(19) United States
(12) Patent Application Publication
(10) Pub. No.: US 2015/0107200 A1
(43) Pub. Date: Apr. 23, 2015

(54) Filter Device, Especially Air Filter

(71) Applicant: MANN+HUMMEL GMBH, Ludwigsburg (DE)

(72) Inventors: Joerg Menssen, Markgroeningen (DE); Karlheinz Muenkel, Oberderdingen-Flehingen (DE)

(21) Appl. No.: 14/590,071

(22) Filed: Jan. 6, 2015

Related U.S. Application Data
(63) Continuation-in-part of application No. 13/445,325, filed on Apr. 12, 2012.
Application No. 13/445,325 is a continuation of application No. PCT/EP2010/064930, filed on Oct. 6, 2010.
Application No. PCT/EP2010/064930 is a continuation of application No. 13/681,855, filed on Nov. 20, 2012, now Pat. No. 8,926,724.
Application No. 13/681,855 is a continuation of application No. PCT/EP2010/064930, filed on Oct. 6, 2010.
Application No. PCT/EP2010/064930 is a continuation-in-part of application No. 12/589,527, filed on Feb. 26, 2009, now Pat. No. 8,313,549.
Application No. 12/589,527 is a continuation of application No. PCT/EP2009/052315, filed on Feb. 26, 2009.

(30) Foreign Application Priority Data
Feb. 26, 2008 (DE) 10 2008 011 186.4
Oct. 9, 2009 (DE) 10 2009 049 170.8
Mar. 30, 2012 (DE) 102012006426.8

(51) Int. Cl. F02M 35/024; B01D 46/52; B01D 46/00

(52) U.S. Cl. CPC F02M 35/02416; B01D 46/0024; B01D 46/521; B01D 46/0005; F02M 35/02475
USPC 55/482

(57) ABSTRACT

A filter device comprises a filter element in a filter housing, wherein the filter housing is to be closed by a cover element. A friction section of the cover element, in an intermediate position between closed and open positions, is in friction contact with a friction member while in the closed position of the cover element the friction section is without friction contact with the friction member.

### CROSS REFERENCE TO RELATED APPLICATIONS

This application is a Continuation of U.S. Pat. No. 13/681,855 filed Mar. 30, 2012 which is a Continuation in Part of U.S. Pat. No. 13/445,325 filed Apr. 12, 2012 which is a US Bypass Continuation of International Application No. PCT/EP2010/064930 having a filing date of Oct. 6, 2010 and designating the United States, the International Application claiming a priority date of Oct. 12, 2009 based on prior filed German patent application No. 10 2009 049 170.8, the entire contents of the aforesaid U.S. Pat. No. 13/445,325 being incorporated herein by reference. Further, U.S. Pat. No. 13/681,855 is a Continuation in Part of U.S. Pat. No. 12/589,527 filed Feb. 26, 2009, now U.S. Pat. No. 8,313,549 which claims priority to International Application No. PCT/EP2009/052315 filed Feb. 26, 2009 designating the United States. U.S. Pat. No. 12/589,527 further claims a priority date of Feb. 26, 2008 based on prior filed German patent application No.10 2008 011 186.4, the entire contents of the aforesaid U.S. Pat. No. 12/589,527 being incorporated herein by reference. U.S. Pat. No. 12/589,527 further claims priority to German patent application No.102012006426.8 filed Mar. 30, 2012, the entire contents of German patent application No.102012006426.8 being incorporated herein by reference. The present application is a Continuation in Part of U.S. Pat. No. 13/445,325 filed Apr. 12, 2012 which is a US Bypass Continuation of International Application No. PCT/EP2010/064930 having a filing date of Oct. 6, 2010, the International Application claiming a priority date of Oct. 12, 2009 based on prior filed German patent application No. 10 2009 049 170.8.

### TECHNICAL FIELD

The invention concerns a filter device, in particular an air filter for an internal combustion engine.

### PRIOR ART

EP 1 364 695 A1 discloses an air filter for an internal combustion engine that comprises in a filter housing a wound filter element which is flowed through axially by the air to be filtered. The filter element is inserted into a receiving chamber in the filter housing that is open in upward direction and can be closed by a cover element. This embodiment has the advantage that the cover element is positioned outside of the axial flow path through the filter element.

The cover element has two lateral projections which extend downwardly from a cover base member, covering the receiving opening in the inserted state, and which are resting between the exterior side of the filter element and the inner wall of the filter housing. For opening, the cover element must be lifted and friction between the projections and the filter element or the inner housing wall must be overcome.

### SUMMARY OF THE INVENTION

The invention has the object to configure with simple constructive measures a filter device in such a way that a cover element on the filter housing is safely secured in the closed state and opening of the cover element can be performed safely and without the risk of injury.

The filter device is preferably an air filter, in particular for an internal combustion engine, wherein basically also other uses or applications are conceivable, for example, as a liquid filter. The filter device has a filter element that is flowed through by the fluid to be cleaned and is exchangeably received in a receiving chamber of a filter housing. The receiving chamber in the filter housing can be closed by a cover element that is embodied as a separate component embodied independent of the filter housing and is preferably frictionally secured on the filter housing in the closed position. For opening, the cover element must be removed against the frictional locking action from its position on the filter housing.

Advantageously, the cover element is secured exclusively by frictional locking action on the filter housing.

In principle, as an alternative or in addition to the frictional locking action in the closed cover position, other securing means of the cover element on the filter housing are conceivable also, for example, closure elements or form fit.

Moreover, it is provided that a friction section of the cover element, in an intermediate position between closed and open cover position, is in friction contact with a friction member. At least in the intermediate position in which the cover element is still arranged on the filter housing but already lifted from the closed position, friction contact exists by means of the friction section of the cover element and the friction member that is arranged on the filter housing and/or on a component that is connected to the filter housing. In contrast to this, in the closed position of the cover element there is no or only a reduced friction contact between the friction section on the cover element and the friction member.

Various advantages are achieved with this embodiment. On the one hand, by means of the friction contact additional safety against accidental release of the cover element is provided. Moreover, during the detachment or opening action of the cover element, a friction contact is provided at least phase-wise. As soon as the initial friction between cover and filter element has been overcome, the friction can drop for example to zero or a small value before the friction member reaches the friction section of the cover element. This reduces the danger that the user, when removing the cover element in case of tight space conditions, for example, under the hood or in a motor area of a motor vehicle, will hit his hands and be injured. Instead of a sudden drop of the friction forces during release of the cover a continuous reduction of the friction is now achieved. Accordingly, the release forces for removing the cover element are reduced.

Inasmuch as the cover element is also secured in the closed state by frictional locking action, the friction between the friction section on the cover element and the friction member compensates at least partially the friction force acting on the cover element in the closed state and being reduced during the opening process. Since on the other hand in the closed state no friction contact between the friction section of the cover element and the friction member exists, the friction is not further increased when the cover is closed so that release of the cover is possible without increased force expenditure. Only after the cover element has been lifted slightly, the friction contact between the friction section on the cover element and the friction member is created which, as described above, counteracts the sudden drop of the friction forces. The forces that are created upon contact between the friction section and the friction member are expediently however smaller than the friction force in the closed state of the cover element.

Even in case that the cover element in the closed state is locked by form fit or by securing elements on the filter housing, a safety gain is obtained with the embodiment according to the invention. After release of form fit or of the securing elements, the friction section comes into contact with the friction member as the cover element is removed so that a friction force is generated and the force for removing the cover element increases up to a maximum. This prevents a sudden removal of the cover element which could lead to injuries.

Basically, various embodiments are conceivable for the arrangement or positioning of the friction member on the filter devices. Possible is, for example, that the friction member is arranged on the exterior side of the filter element and/or on the inner wall of the filter housing. A portion of the cover element projects in the closed state into the filter housing and is located between the exterior side of the filter element and the inner side of the housing wall. Accordingly, the friction member can be arranged on one of the sides or on both sides.

The friction section of the cover element can optionally have an increased friction coefficient in order to increase the friction forces as soon as the friction section comes into contact with the friction element. However, possible in principle is also a smooth-walled embodiment of the friction section. Moreover, it is possible that the friction member is not arranged on the filter housing or on the filter element but on the cover element and the correlated friction section on the inner wall of the filter housing or the exterior side of the filter element. This is simply a reversal of the arrangement of friction section and friction member.

The friction section is located preferably on a cover projection which extends angularly relative to a cover base member of the cover element and preferably is formed monolithically with the cover base member that covers with closed cover element the opening in the filter housing by means of which the filter element is insertable into and removable from the receiving chamber in the filter housing. Advantageously, the cover element has two parallel arranged spaced-apart cover projections that engage the filter element and are positioned on oppositely positioned exterior sides of the filter element. Each cover projection is preferably provided with a friction section that has correlated therewith a friction member on the filter housing or the filter element, respectively. The cover projections can be elastically attached on the cover base member and in the closed cover position or in an intermediate position can be bent outwardly between the closed and open cover positions wherein, as a result of the elasticity, a clamping force is generated by means of the two cover projections that secures the intermediately positioned filter element; the friction or release force for removing the cover element is orthogonal to the clamping force. In particular in the embodiment with the friction member on the exterior side of the filter element, the desired friction force is generated in this way in the intermediate position.

According to a further embodiment, on the cover element a recess that is adjacent to the friction section is arranged which serves for receiving the friction member in the closed cover position. By means of the recess it is ensured that in the closed cover position the friction element and the friction section are positioned adjacent to each other and no or only a minimal friction force is produced between the part of the cover element that receives the friction section and the friction member. Only during removal of the cover element the friction section will come into contact with the friction member and generate a friction force in the desired way.

The transition between the recess and the friction section is advantageously ramp-shaped so that upon removal of the cover element a continuous increase of the friction force is ensured which is the result of the contact of the friction member on the cover element. When the friction section is reached, the friction force reaches its maximum. Along the further course, i.e., in the direction to the end face of the part of the cover element that receives the friction section, the friction section can optionally also descend, preferably in a ramp shape, so that after reaching the friction maximum a continuous decrease of the friction force is realized until complete release of the cover element is provided. Advantageous is also an embodiment with parallel orientation of the friction section.

The friction member on the exterior side of the filter element or the inner side of the filter housing can be designed differently. Conceivable is a friction member of rubber or TPE or different geometric configurations, for example, in the form of a straight friction bead which extends in particular transversely to the release direction of the cover element.

### BRIEF DESCRIPTION OF THE DRAWINGS

Further advantages and expedient embodiments can be taken from the further claims, the figure description, and the drawings. It is shown in:

FIG. 1 a perspective view of an air filter with a filter housing onto which a cover element is placed;

FIG. 2 an air filter with removed cover element;

FIG. 3 a partial view with closed cover element wherein a friction member is positioned on the exterior side of the filter element in a recess of a cover projection of the cover element;

FIG. 4 the air filter with the cover element in a slightly lifted intermediate position in which the friction member is contacting a ramp-shaped section on the cover projection;

FIG. 5 the cover element in a perspective view;

FIG. 6 a filter element in perspective illustration;

FIG. 7 a detail of the filter element with the friction element;

FIG. 8 the friction element in a detail illustration;

FIG. 9 a section of a filter element, showing the nested multiple filter media bellows construction.

In the Figures the same components are provided with same reference characters.

### EMBODIMENT(S) OF THE INVENTION

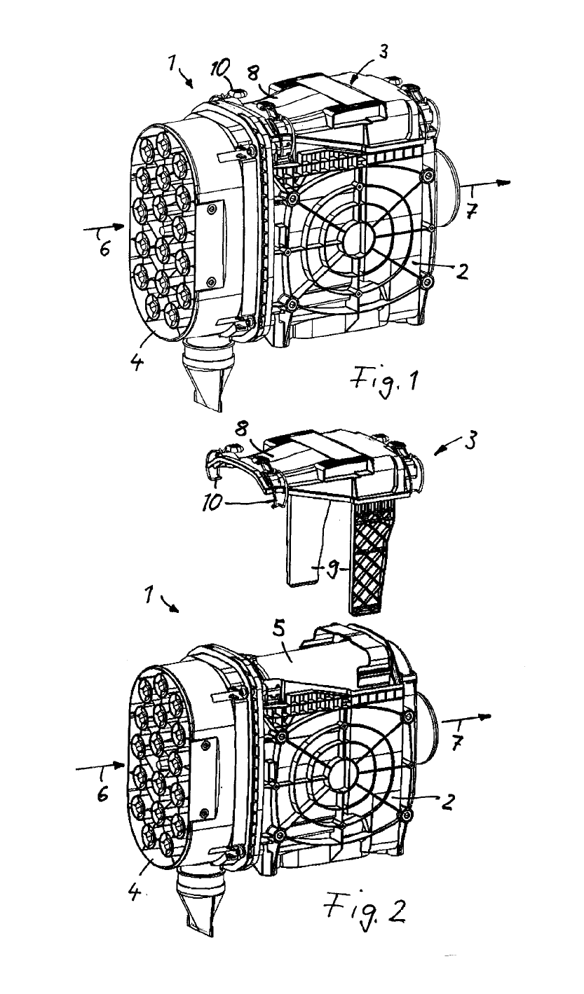

As can be seen in FIGS. 1 and 2, the filter device 1 that is embodied as an air filter for an internal combustion engine comprises a filter housing 2 for receiving a filter element 5 (FIG. 2) that can be inserted exchangeably into a receiving chamber in the filter housing 2. The filter housing has an opening at the top by means of which the filter element 5 can be inserted or removed and which can be closed off by a cover element 3 which is shown in the closed state in FIG. 1 and in the open state in

FIG. 2. The air filter is axially flowed through as indicated by arrows 6 and 7 wherein on the inflow side a cyclone preseparator 4 is arranged upstream of the filter element.

The cover element 3 has a cover base member 8 as well as two cover projections 9 that are formed monolithically with the cover base member and extend angularly thereto and are arranged parallel to each other and spaced apart from each other. The cover projections 9 have a bending elasticity and project when the cover element is closed into the intermediate space between the exterior side of the filter element 5 and the inner wall of the filter housing 2. When the cover 3 is closed, the cover projections 9 are secured with friction force on the filter element 5 or the inner wall of the filter housing 2. As additional securing means securing or closure elements 10 are provided which are arranged on the cover base member 8 and by means of which the cover element 3 is connected with the filter housing 2.

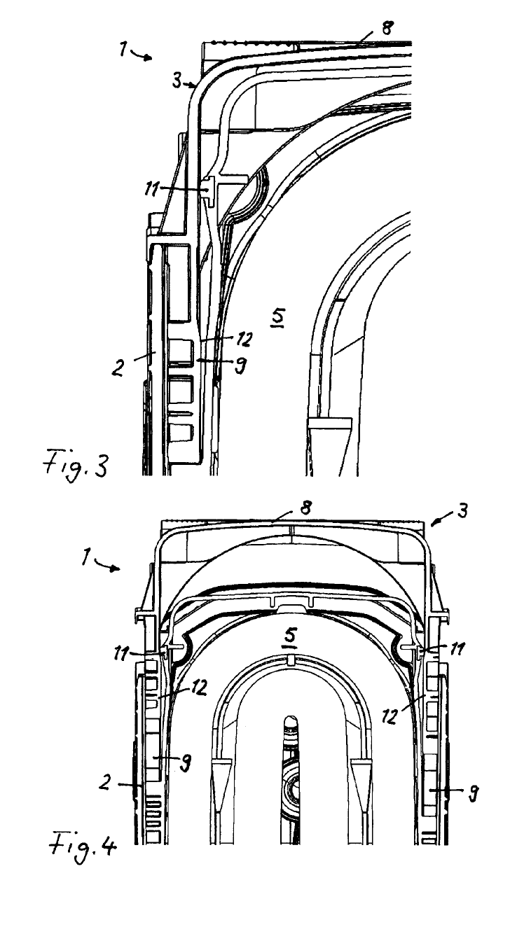

FIG. 3 shows the air filter 1 with closed cover element 3. FIG. 4 shows the air filter with the cover element in partially lifted intermediate position. On oppositely positioned exterior sides of the filter element 5, a friction member 11 is arranged, respectively, which in the intermediate position according to FIG. 4 is in contact with a ramp-shaped ascending slope on the inner side of each cover projection 9 wherein the ramp-shaped ascending slope extends up to a friction section 12 that, relative to the other sections on the cover projection 9, is projecting maximally inwardly. Along the further course, the friction section 12 drops straight in the direction of the free end face of the cover projections 9 so that the friction sections 12 on the two cover projections 9 extend parallel to each other.

When the cover element 3 is closed (FIG. 3), the friction member 11 is resting on an area of the cover projection 9 that projects less far inwardly. In this way it is ensured that, when the cover element is closed, no or only minimal friction force is acting between the friction member 11 and the cover projection 9 so that the cover element 3, after release of the closure element 10 and overcoming an initial friction, can be lifted from its seat in the filter housing. During lifting or opening movement of the cover element 3, the friction member 11 first comes into contact with the ramp-shaped ascending slope at the inner side of the cover projection and finally contacts the friction section 12 that represents the farthest inwardly projecting section. In this position, the friction force between cover projection 9 and friction member 11 is highest. This friction force compensates at least partially the reduction of the initial friction which must be overcome in order to lift the cover element from its seat in the filter housing.

The cover projections 9 are arranged elastically and springy on the cover base member 8 and upon insertion into the filter housing are bent outwardly so that, as a result of the elasticity, an inwardly acting force is exerted in radial direction with which the cover projections 9 are resting on the friction member 11. When the cover element is closed, the force is minimal or zero but it increases when reaching the ramp-shaped ascending slope and reaches a maximum in the area of the friction section 12.

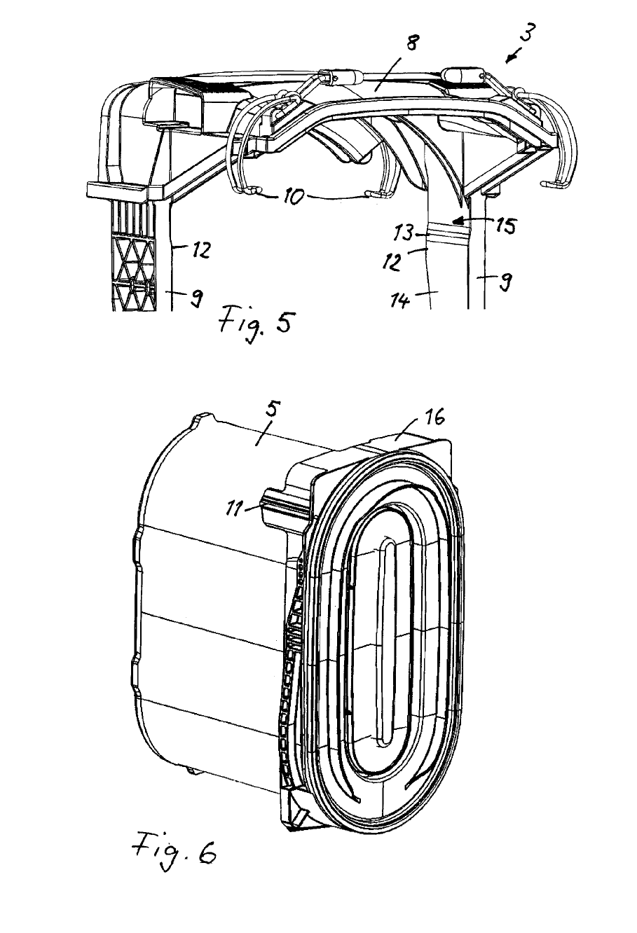

FIG. 5 discloses the configuration of the inner surface of the cover projections 9 in detail. Viewed in the direction of the free end face of the cover projections 9, at the inner surface first the ramp-shaped ascending slope 13 begins which extends up to the friction section 12 that projects farthest inwardly. Along the further course the friction section 12 drops straight in the direction of the free end face of the cover projection 9 in the section 14 so that the friction sections 12 on the two cover projections 9 are parallel to each other. Immediately in front of the ramp-shaped ascending slope 13, on the side that is facing the cover base member 8, a recess 15 relative to the ramp-shaped ascending slope and the friction section 12 is provided on the inner side on which the friction member 11 is resting without friction when the cover element is closed (FIG. 3).

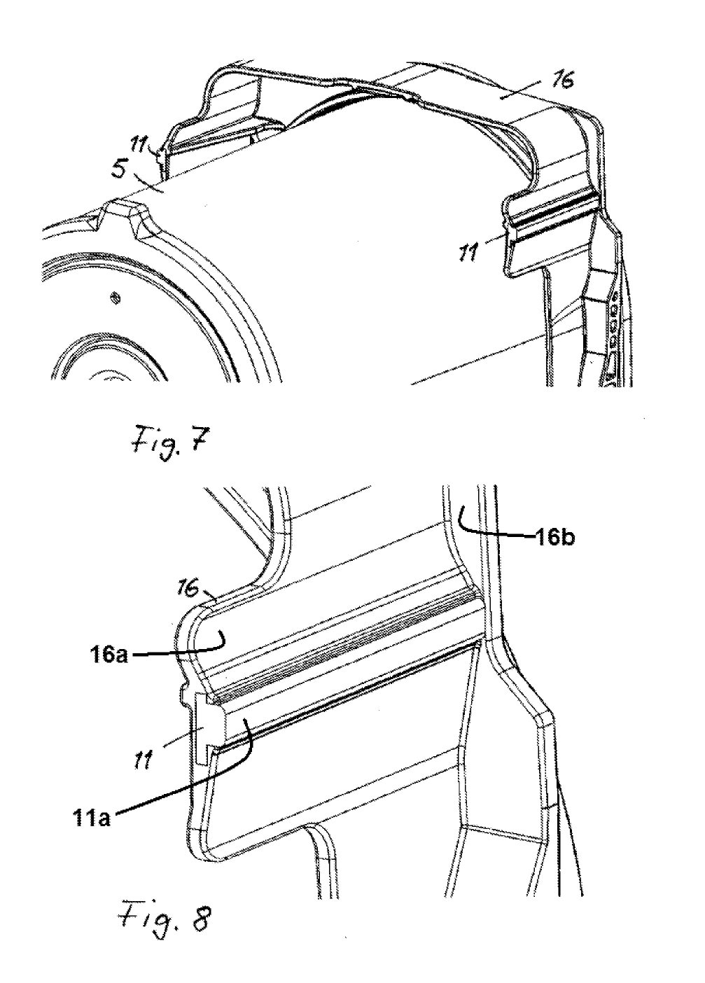

In the FIGS. 6 to 8 the friction member is illustrated in detail; it is arranged on a frame 16 which is adjacent to an end face of the filter element 5 and surrounds the filter element 5. The friction element 11 which, for example, is made of rubber or TPE is of a straight configuration and forms a friction bead which extends in axial direction, i.e., in the flow-through direction, of the filter element 5. Relative to the removal direction of the cover element, the friction member 11 extends in transverse direction so that the friction member 11 across its length is in contact with the ramp 13 as well as the friction section 12 or 14.

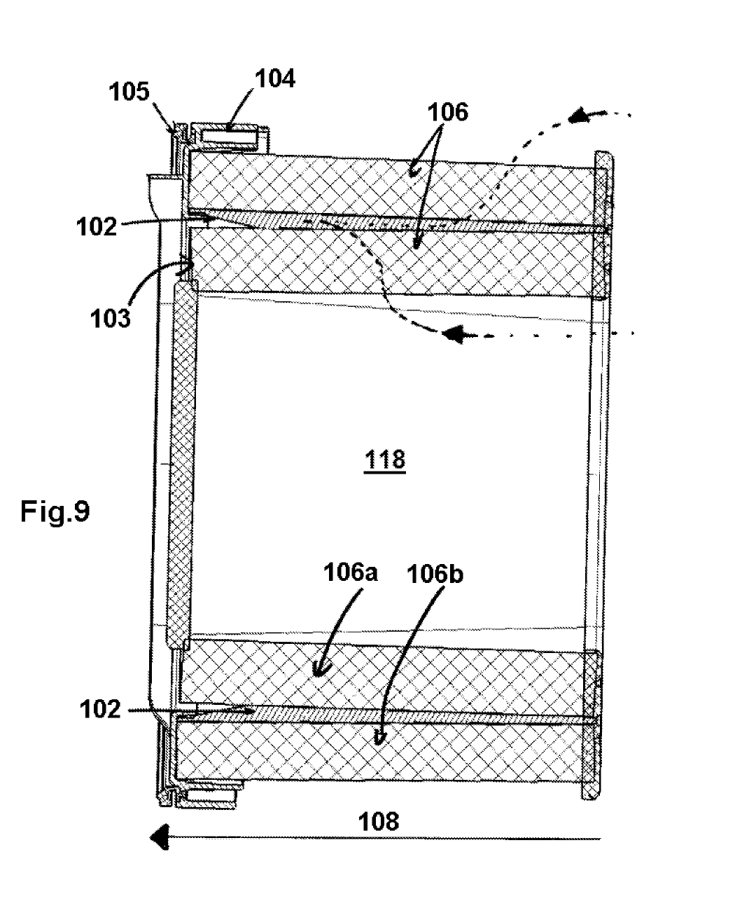

As shown in FIGS. 6-8 with reference to FIG. 9, the frame 16 is arranged on an axial end surface 103 of the second or radially outwards filter bellows 106b (see FIG. 9) and connected to the second filter bellows 106b. The frame member 16 radially surrounds the first flow space 118 and the second flow space 102.

As can be seen in FIG. 8, the frame includes an axially extending frame portion 16a extending radially over the radially outer surface of the second filter bellows. The friction element 11 is arranged on and secured onto a radially outer surface of the axially extending frame portion 16a. The friction element 11 is configured and adapted to frictionally engage with a housing cover to secure the cover onto the filter housing.

The friction element 11 forms an axially extending friction bead 11a projecting radially outwardly from the axially extending frame portion 16a, the friction bead 11a extending in an axial direction on the axially extending frame portion 16a.

The frame 16 includes a radially extending flange 16b, the flange 16b arranged on the axial end surface of the second filter bellows 106b. The axially extending frame portion 16a is formed on an axially inwardly facing side of the radially extending flange 16b.

FIG. 9 shows an embodiment of a filter insert according to the invention. In this embodiment, on the end surface 103 of the filter element 106 at the outlet side a frame 104 is arranged that supports an axially acting seal 105. The filter element 106 is comprised of two star-shape folded annular filter media bellows 106a and 106b. The filter media bellows each have an oval cross-section with two straight parallel sections positioned opposite one another. A smaller filter media bellows 106a is concentrically arranged within the annular space that is enclosed by the larger filter media bellows 106b such that between the filter media bellows a flow passage 102 is provided for the medium to be filtered that is passing through.

In the area of the end surface 103 at the outlet side of the filter element 106 the flow passage 102 provides the outflow opening of the filter element 106, while at the end surface at the inlet side the filter media bellows 106a, 106b are seal tightly connected with one another. The interior of the smaller filter media bellows 106a is closed off seal-tightly in the area of the end surface 103 at the outlet side by an end disk or a similar structural element.

In this way, the larger filter media bellows 106b is flowed through from the exterior to the interior and the inner filter media bellows 106a from the interior to the exterior.

In this way, by means of the filter insert a deflection of the flow is achieved wherein the flow deviates from the main flow direction 108 that is defined by the connection of the end surface at the inlet side to the end surface 103 at the outlet side.

The frame 104 surrounds in the area of the end surface 103 at the outlet side the lateral sides of the filter element 106.

What is claimed is:

1. A filter element for a filter device, comprising:
axially opposing intake side and outflow side;
an intake end face arranged at said intake side at a first axial end of said filter element, said intake end face having an axial intake opening through which fluid to be filtered enters said filter element;
an outlet end face arranged at an opposing second axial end of said filter element, said outlet end face having an axial outlet opening through which filtered fluid exits said filter element;
wherein said filter element is embodied as a multi-bellows filter with at least two radially nested filter bellows;
wherein said intake opening and said outlet opening are at opposing axial ends of said filter element;
a first filter bellows with filter media folds extending axially between said intake end face and said outlet end face;
wherein said first filter bellows radially surrounds and delimits an axially extending first flow space within said first filter bellows;
wherein said first flow space is in flow communication with only one of said intake opening or said outlet opening;
a second filter bellows with filter media folds extending axially between said intake end face and said outlet end face, said second filter bellows construction arranged radially outwards of and radially surrounding said first filter bellows;
wherein a second flow space is defined in an annular gap between a radially outer surface of said first filter bellows and a radially inner surface of said second filter bellows;
wherein said second flow space is in flow communication with a different one of said intake opening or outlet opening than said first flow space;
wherein said filter element is a one-piece component inserted into and removed from filter housing as a single component;
wherein said second filter bellows is a star-shaped filter with filter folds arranged in a star shape and on at least one end face of the filter element a seal is arranged between said second filter bellows and the filter housing;
wherein a third flow space is provided at a radially outer surface of said second filter bellows;
wherein said third flow space is in flow connection with said first flow space; such that said first flow space and said third flow space are on same filtered or unfiltered side of said filter element;
a frame member arranged on and connected to an axial end surface of the second filter bellows, the frame member radially surrounding the first flow space and the second flow space.

2. The filter element according to claim 1, wherein
the frame member includes an axially extending frame portion extending radially over the radially outer surface of the second filter bellows;
wherein a friction element is arranged on and secured onto a radially outer surface of the axially extending frame portion;
wherein the friction element is configured and adapted to frictionally engage with a housing cover of the filter housing.

3. The filter element according to claim 1, wherein
the friction element forms an axially extending friction bead projecting radially outwardly from the axially extending frame portion, the friction bead extending in an axial direction on the axially extending frame portion.

4. The filter element according to claim 3, wherein
the friction bead is embodied as a straight friction bead.

5. The filter element according to claim 1, wherein
the frame member includes
a radially extending flange, the flange arranged on the axial end surface of the second filter bellows;
wherein the axially extending frame portion is formed on an axially inwardly facing side of the radially extending flange.

6. The filter element according to claim 1, further comprising:
an axially acting seal arranged on the radially extending flange, wherein said seal is adapted to be pressed against a sealing surface of a filter housing in a sealing direction.
